(19) United States
(12) Patent Application Publication
(10) Pub. No.: US 2026/0121788 A1
(43) Pub. Date: Apr. 30, 2026

(54) LINK ADAPTATION WITH DYNAMIC BACKOFF OPTIMIZATION

(71) Applicant: T-Mobile USA, Inc., Bellevue, WA (US)

(72) Inventors: Maher Hasan, Ashburn, VA (US); Roopesh Kumar Polaganga, Bothell, WA (US); Sirisha Potlabathini, Reston, VA (US)

(21) Appl. No.: 18/933,989

(22) Filed: Oct. 31, 2024

(51) Int. Cl. H04L 1/00; H04B 17/336; H04L 1/20; H04W 52/22

(52) U.S. Cl. CPC H04L 1/0021; H04B 17/336; H04L 1/203; H04W 52/228

(57) ABSTRACT

This disclosure describes techniques that can be used for dynamic link adaptation in wireless telecommunications networks. Some implementations relate to determine signal to interference and noise (SINR) back off values, which can be used to determine adjustments to transmission characteristics such as transmission power for improving throughout. In some implementations, block error rates are used to determine adjustments to transmission power. In some implementations, slot-specific adjustments are determined. Reinforcement learning can be used to determine adjustments in real time or nearly real time.

### BACKGROUND

Errors in transmission of data over wireless telecommunications networks can result in significant performance degradation as information is retransmitted. Wireless telecommunications networks have significant resource constraints. Thus, limiting the use of limited resources for retransmission is important. Current approaches to reducing transmission errors have significant deficiencies. Thus, there is a need for improved approaches for reducing transmission errors.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram that illustrates an architecture including 5G core network functions (NFs) that can implement aspects of the present technology.

FIG. 3 is a table that illustrates an example of slot-specific BLER.

FIG. 4 is a diagram that schematically illustrates reinforcement learning according to some implementations.

FIG. 5 is a block diagram that schematically illustrates link adaptation according to some implementations.

FIG. 6 is a flowchart that illustrates an example process for adjusting a SINR backoff according to some implementations.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Reliable and efficient data transmission are key for wireless telecommunication. Wireless telecommunications networks typically have limited resources that need to be carefully managed to achieve performance goals. For example, a wireless telecommunications carrier may have limited radio frequency spectrum allocation, which is shared among users. Additionally, different frequency bands have different characteristics. For example, lower frequency bands typically offer better range and building penetration, but provide less bandwidth, while higher frequency bands can carry more data but have a more limited range and are more highly impacted by obstacles such as buildings. Interference from other electronic devices, radio frequency sources, and so forth can decrease performance of a wireless telecommunications service. In some cases, weather conditions can result in a degradation of network performance. High error rates in data transmissions can result in significant amounts of re-transmission, which can consume resources and degrade the experience of the user receiving the data and other users connected to the same base station.

The block error rate (BLER) quantifies the accuracy of data transmission, while the signal-to-interference-plus-noise ratio (SINR) gauges signal quality. BLER measures the probability of data blocks being receiving with errors. A low BLER is desirable because it means fewer blocks need to be retransmitted. BLER can be influenced by a variety of factors, such as interference, noise, modulation coding scheme (MCS), and so forth. High BLER indicates poor transmission quality, which can be experienced by users as slower data rates, failed transmissions, and so forth. SINR quantifies the quality of a received signal relative to interface and noise. SINR can be affected by factors such as distance from a cell site, interference from radio sources, and so forth.

SINR backoff is a technique that can be used to manage BLER, which can improve performance of the network. SINR backoff can be used to improve performance both with respect to specific user equipment (e.g., a specific smartphone or other device) and for other connected devices, as limited resources are less likely to be consumed retransmitting data to a device experiencing high BLER.

High interference and/or noise can lead to higher BLER. SINR backoff can be used to improve BLER, thereby achieving more reliable data transmission. SINR backoff strategies can involve dynamically adjusted transmission characteristics. In some cases, poor SINR can be mitigated using techniques such as adaptive beamforming, power control, or using interference mitigation algorithms. In some cases, poor SINR can be mitigated by selecting a different channel or modulation scheme for communicating with a particular device.

In some cases, when BLER reaches or exceeds a threshold value, indicating poor transmission quality, SINR backoff can be used to improve transmissions. This can result in improved connection stability, throughput, capacity, and/or the like.

In conventional approaches, SINR backoff values are often set statically. SINR backoff values may be set to a static value for a base station, for multiple base stations in an area, or even for all base stations in a wireless telecommunications network. However, static approaches can provide poor results, as the appropriate SINR backoff value can depend on the particular cell site, devices communicating with the cell site, conditions at the cell site, and so forth. For example, the appropriate SINR backoff can be different based on where a base station is located (e.g., in an area with a lot of radio interference or not), current weather conditions, the number of devices in the area, and so forth.

It can be important to set SINR backoff values that are suited to actual conditions at a base station. If a SINR backoff value is set too high, signal strength, transmission speeds, and/or the like may be poor or otherwise negatively impacted. If a SINR value is set too low, there can be a high BLER and poor performance. Thus, it can be important to set a SINR backoff that is appropriate for the actual conditions being observed.

The approaches described herein can be used to reduce BLER or otherwise improve performance of a wireless telecommunications network by adjusting SINR backoff values. In some implementations, SINR backoff values are slot-specific. In some implementations, SINR backoff values can be updated based on actual, observed conditions. The approaches herein can be used for various networks, such as LTE networks and/or 5G networks, can work for both time division duplexing (TDD) and frequency division duplexing (FDD), and can be used for uplink, downlink, or both.

BLER can vary by slot, modulation, rank (e.g., number of MIMO layers), and so forth. In some cases, high BLER can be caused by channel state information reference signal (CSI-RS) or tracking reference signal (TRS) to physical downlink shared channel (PDSCH) interference, which can result in high BLER at CSI-RS slots. In some cases, there can be erroneous CSI feedback in certain combinations of MCS, rank, and slot. In some cases, BLER may be more prominent in downlink slots following closely (e.g., immediately) after an uplink slot for time-division duplexing (TDD) network configurations. In some cases, high BLER can be caused by external interference from devices that use radio technology and/or out-of-band emissions from broken or malfunctioning equipment.

Various modulation schemes are available for use by a wireless telecommunications network. For example, quadrature amplitude modulation (QAM) is commonly used in wireless telecommunications networks and varies the phase and amplitude of carrier waves to achieve different transmission characteristics (e.g., lower error rates, higher throughput, etc.). Within the context of QAM, there are various modulation schemes in which different numbers of signal states are used. For example, modulation schemes can include 4QAM, 16QAM, 32QAM, 64QAM, 128QAM, 256QAM, 1024QAM, 4096QAM, and so forth. The number can indicate how many bits of data can be encoded per symbol. In general, the number of bits that can be encoded per symbol is given by the base two logarithm of the number. For example, 4QAM can encode 2 bits per symbol, 16QAM can encode 4 bits per symbol, and so forth. As the QAM value increases, data rate capabilities increase; however, higher QAM values (more bits per symbol) can also result in increased sensitivity to noise.

Wireless telecommunication networks can use various information and approaches to determine a modulation scheme for transmission between base stations and user equipment. For example, the network can measure signal quality using factors such as signal strength (e.g., RSSI), signal to noise ratio (SNR), channel impulse response, and so forth. In some implementations, user equipment can be configured to estimate channel conditions based on the measured signal quality and can report a channel quality indicator (CQI) to a base station. The CQI value can indicate modulation and coding schemes (MCSs) that the user equipment can operate on given specific channel conditions.

The base station can receive CQI feedback from the user equipment and, based on the CQI feedback, the base station's own data related to channel conditions, or both, the base station can select an MCS. In some implementations, MCS can be selected to achieve a desired balance of transmission rate and communication reliability.

As described herein, one way to improve channel quality is to adjust SINR backoff. In some cases, adjusting SINR backoff may not improve performance to a desired level. For example, even after adjustment, BLER can remain too high. In some cases, additional SINR backoff adjustments are made. In some cases, an MCS is changed, for example to a lower QAM value that provides increased reliability at the cost of speed, for example, from 256QAM to 64QAM.

In some implementations, a machine learning model is training to determine SINR backoff values. For example, a reinforcement learning agent can be trained to determine SINR backoff values, as described in more detail herein. The use of a reinforcement learning agent can help to dynamically manage SINR backoff values based on real time or nearly real time conditions.

### Reinforcement Learning

Reinforcement learning is a type of machine learning in which an agent learns to make sequential decisions by interacting with an environment. Reinforcement learning operates by trial and error, guided by rewards and penalties.

In reinforcement learning, an agent takes an action and observes the resulting changes, which can be used to determine a reward. The agent learns a mapping of states and actions that can maximize the reward over time. The agent can use an explore-exploit mechanism, in which new actions are carried out while also exploiting known actions that yield higher rewards.

Reinforcement learning algorithms can utilize various techniques to optimize the behavior of the agent, such as value iteration, policy iteration, Q-learning, or deep reinforcement learning. Value-based methods can operate by estimating the value of taking actions in different states. Policy-based methods can optimize the agent's policy. The policy can map states to actions. Deep reinforcement learning can use deep neural networks and can be especially beneficial for high dimensional states and action spaces. Q-learning aims to learn an optimal action-value function (a Q function), which represents an expected cumulative reward by taking a particular action in a particular state and following an optimal policy.

Q-learning can use an iterative update rule that allows estimation of Q values via an explore-exploit mechanism. The Q value for each state-action pair can be updated based on an observed immediate reward and an estimated value of a next state. In Q-learning, the algorithm learns an optimal policy independently of an agent's behavior during exploration. Such an approach can ensure convergence to optimal Q values, but can require exploration of a large number of state-action pairs.

In some implementations, learning can take place on a base station (e.g., gNodeB, eNodeB) or on another system, such as a server. In some implementations, learning can take place on user equipment. For example, in some implementations, downlink learning is performed on a base station or server. In some implementations, uplink learning is performed on user equipment, though in other implementations, uplink learning is performed by a base station or other system.

### Dynamic SINR Backoff Adjustment

One approach to setting SINR backoffs is to aggregate data across multiple users, multiple slots, and a relatively long period of time (e.g., a day, a week, a month, or more) to determine a SINR backoff value, and apply the SINR backoff value uniformly and in a static manner. In some cases, a single SINR backoff value is used across multiple cell sites; however, different cell sites can have different performance characteristics that can be impacted by radio interference sources, physical obstacles, and so forth. This can lead to some sites having SINR backoff values that are set too high and other sites having SINR backoff values that are set too low. Such misconfigurations can result in diminished performance.

Adjusting SINR backoffs has generally been considered an offline operation, thus limiting when SINR backoffs can be adjusted (e.g., only during maintenance windows, only during periods of low utilization, etc.). Such an approach can have many drawbacks. For example, different user equipment (e.g., smartphones, tablets, watches, high speed internet gateways, etc.) can perform differently, different modulation schemes can show different BLER, different slots can show different BLER, and so forth. As an example, different radios and/or antenna configurations in devices can result in different performance characteristics. In some cases, even devices of the same make and model can perform differently. For example, a smartphone that has been dropped may have a damaged antenna, or a phone in a case may block more signal than one without a case.

BLER can vary even throughout the day, for example based on the number of users in a geographic location, other radio activity in a location, and so forth. In some cases, BLER can be affected by weather conditions. Weather conditions can impact different frequencies in different ways. For example, adverse weather conditions may have a greater impact at higher frequencies. In some cases, weather conditions may be suitable for tropospheric ducting to occur, which can result in interference from radio sources located at long distances from a cell site.

Accordingly, there is a need for improved approaches to managing BLER in a wireless telecommunications network. In some implementations, the approaches described herein can be used to set SINR backoff values for specific combinations of, for example, modulation scheme, frequency, slot, user (e.g., based on connected user equipment or observed wireless performance characteristics of connected user equipment), and so forth. In some implementations, SINR backoff values can be set dynamically, thus enabling optimization of SINR backoff values based on current or nearly-current BLER (or other channel quality metrics).

Link adaptation can be used to improve certain performance characteristics of a wireless telecommunications network. Current approaches to addressing BLER can use outer loop link adaptation and inner loop link adaptation. Outer loop link adaptation and inner loop link adaptation are two mechanisms that can work together to optimize performance of a communication link. Outer loop link adaptation operates at a relatively slow time scale and can be responsible for adjusting certain parameters such as transmission power, modulation scheme, etc., based on long-term channel conditions. Inner loop link adaptation can operate at a faster time scale and can be used to fine-tune parameters such as coding rate or modulation order based on real time or nearly real time channel conditions. Inner loop link adaptation can be particularly important when conditions are changing rapidly, such as when a user is moving at high speeds (e.g., on a train or in a car). For example, outer loop link adaptation can account for long-term conditions in an area, such as radio transmission sources in the area, and so forth, while inner loop link adaptation can be more reflective of current conditions such as transient radio emissions, weather conditions, and so forth.

Slot-specific downlink adaptation can refer to the optimization of a downlink connection on a per-slot basis. Transmission parameters such as modulation scheme, coding rate, and/or transmit power can be adjusted for each slot individually based on, for example, channel conditions, capacity, usage demands, and so forth. In some cases, user equipment such as a smartphone can provide channel state information (CSI) feedback. The CSI feedback can include, for example, signal-to-noise ratios, quality indicators, and/or the like. An adaptation algorithm can process the CSI feedback and/or other data to determine optimized transmission parameters for each slot. In some implementations, the adaptation algorithm considers factors such as quality of service, data rate, system capacity, and so forth.

A SINR backoff value can be an input for determining inner loop link adaptation. In conventional approaches, a static SINR backoff value is used (e.g., a 9 dB SINR backoff). While SINR backoff values can be updated over time, SINR backoff values are conventionally determined by averaging monitoring data over a period of time, and SINR backoff values are only updated during maintenance periods, if at all. Using the approaches described herein, SINR backoff values can be updated automatically and in real time or nearly real time, thereby improving network performance and/or quality.

### Wireless Communications System

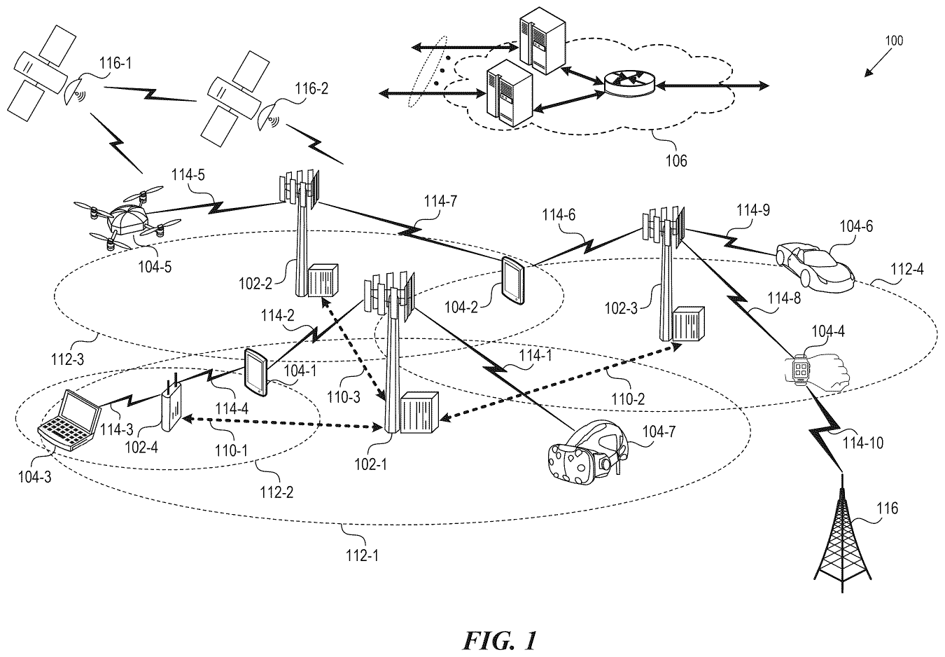

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

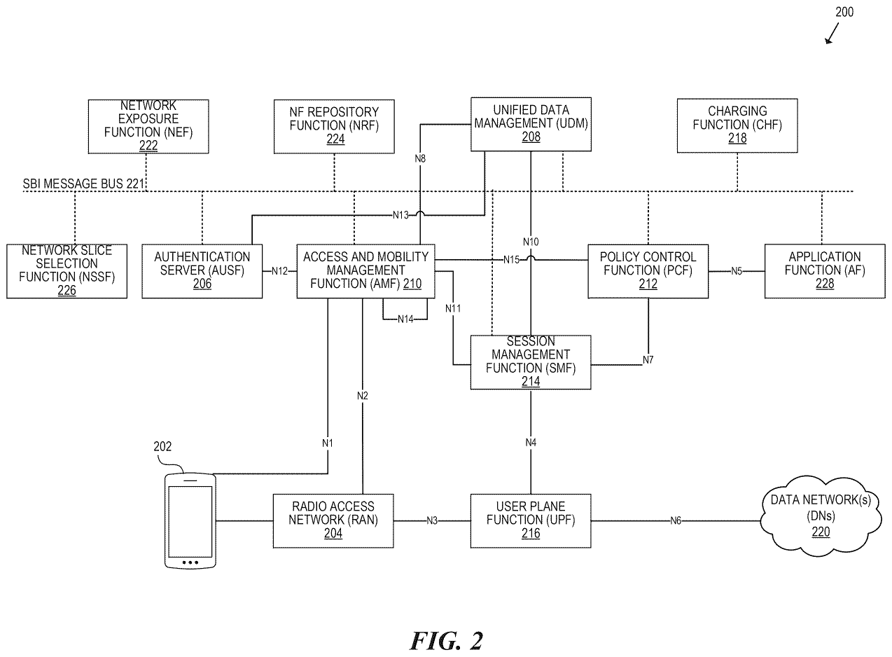

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations

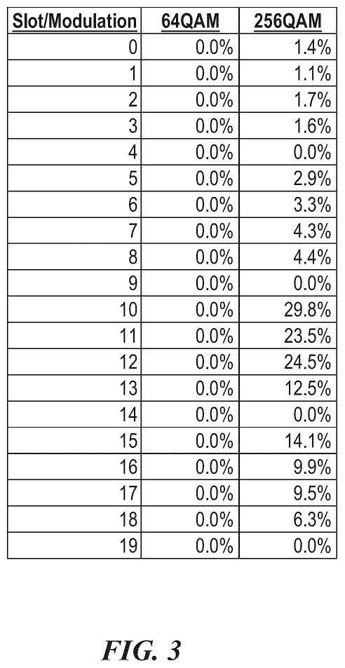

FIG. 3 is a table that illustrates an example of slot-specific BLER. As described herein, different slots can have different BLER values, and different modulation schemes can have different BLER values, with higher QAM values typically being more susceptible to interference and thus typically having greater BLER values. In FIG. 3, the BLER value for 64QAM across all slots is zero, while for 256QAM, some slots have high BLER values while other slots have low or zero BLER values. This information can inform decisions about SINR backoff adjustments. For example, if the BLER value for a particular combination of slot and modulation scheme is below a threshold value (e.g., 5%, 10%, 15%, etc.), no SINR adjustment may be made. In some cases, if BLER is below a threshold value, SINR backoff can be decreased, which may improve performance experienced by users of the network. At or above the threshold value, it may be advantageous to adjust SINR backoff to reduce BLER, which can result in improved performance as there is less need to retransmit data.

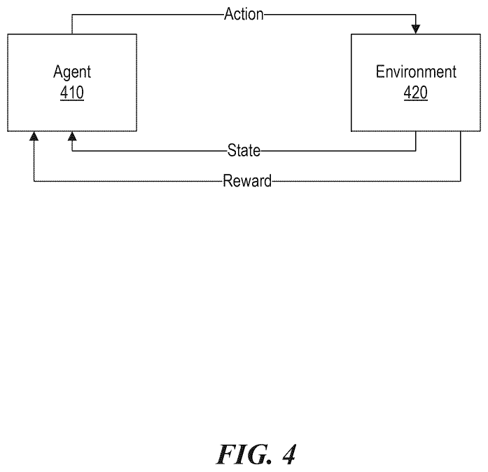

FIG. 4 is a diagram that schematically illustrates reinforcement learning according to some implementations. In FIG. 4, an agent 410 operates on an environment 420. The agent 410 can be a software program that interacts with the environment 420 by performing actions on the environment 420. The agent 410 can receive state information about the environment 420, which the agent 410 can use to determine an action to perform on the environment 420. The agent 410 can receive or otherwise access full state information or partial state information. The agent 410 can receive a reward from the environment 420 or can determine a reward based on the state information. The reward can be a feedback signal that indicates the impact of the action on the environment 420. Through an iterative process of taking actions and receiving rewards, the agent 410 can learn a policy or strategy to maximize a total reward. In the context of SINR backoff, the reward can be, for example, a decrease (positive reward) in BLER or an increase in BLER (negative reward).

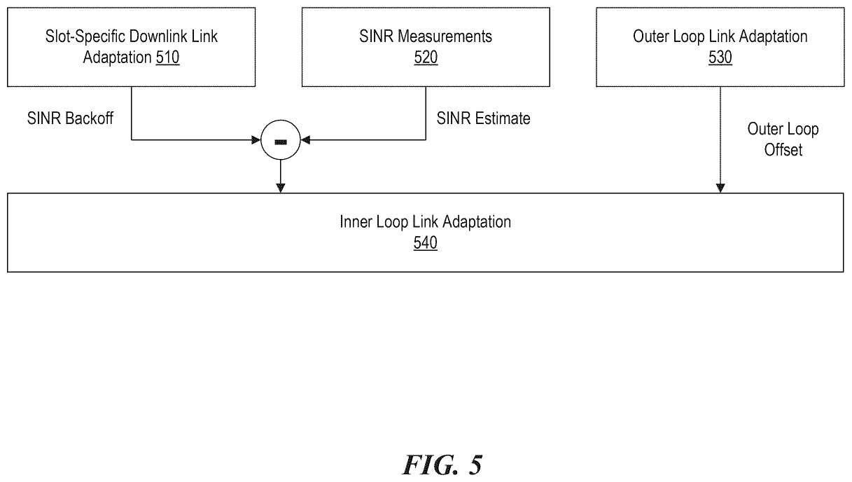

FIG. 5 is a block diagram that schematically illustrates link adaptation according to some implementations. As shown in FIG. 5, outer loop link adaptation 530 can determine or can be used to determine an outer loop offset. SINR measurements 520 can determine or can be used to determine a SINR estimate. Slot-specific downlink link adaptation 510 can be used to determine a SINR backoff value. The SINR-backoff value can be a plurality of values, for example an array of values for different slots, modulation schemes, etc. The SINR estimate, SINR backoff, and outer loop offset can be used for determining inner loop link adaptation 540.

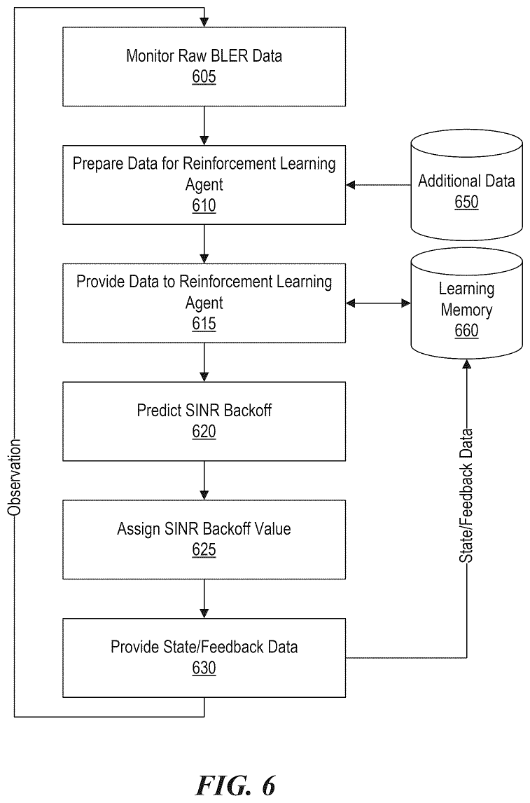

FIG. 6 is a flowchart that illustrates an example process 600 for adjusting a SINR backoff according to some implementations. At operation 605, a system (e.g., a cloud RAN, open RAN, classical RAN, baseband, or a separate server or other computing system) can monitor raw BLER data. At operation 610, the system can process the raw BLER data for use by a reinforcement learning agent or other model. In some implementations, the system can access additional data 650. The additional data 650 can include, for example, information related to device type (e.g., information about devices connected to a network or base station), frequency layer, time of day, geolocation, traffic load, weather conditions, historical patterns, etc. At operation 615, the system can provide the processed data to the reinforcement learning agent or other model, which can, at operation 620, predict or determine a SINR backoff value, for example, based on the prepared data, historical information stored in a learning memory 660, or both. At operation 625, the system can assign the SINR backoff value to a base station. In some implementations, the SINR backoff value can be predicted, assigned, or both at various levels and/or based on various parameters, such as at the cell level, slot level, based upon modulation scheme, based upon cell load, etc. At operation 630, the system can provide state data and feedback data, such as throughput, BLER, etc., which can be stored in the learning memory 660 and used when making subsequent SINR backoff value predictions, which can use the feedback data to make additional SINR backoff predictions. The process 600 can be repeated to adjust SINR backoff values over time. For example, the process 600 can be run continuously, periodically, on a defined schedule, and/or on an ad hoc basis.

### Computer System

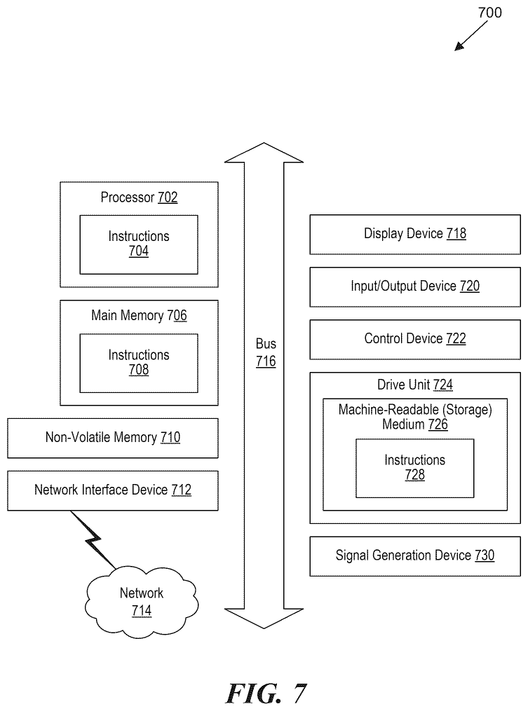

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for adjusting a signal to interference and noise (SINR) backoff value, the method comprising:
accessing first block error rate (BLER) data,
wherein the first BLER data is collected by monitoring BLER at a gNodeB base station of a 5G network for a plurality of slots;
accessing, for each slot of the plurality of slots, a set of features,
wherein the set of features comprises at least one of: device type of a connected device, frequency, frequency band, time of day, geolocation, traffic load, weather conditions, or historical BLER patterns;
providing, for each slot of the plurality of slots, the first BLER data and the set of features to a reinforcement learning agent;
determining, for each slot of the plurality of slots, by the reinforcement learning agent using the first BLER data and the set of features, a SINR backoff value for the slot, wherein the SINR backoff value indicates an amount by which to adjust a transmission power;
providing, for each slot of the plurality of slots, the SINR backoff value to a link adaptation algorithm,
wherein the link adaptation algorithm comprising an outer loop link adaptation algorithm and an inner loop link adaptation algorithm,
wherein the inner loop link adaptation algorithm is configured to adjust one or more transmission characteristics based on an outer loop offset determined by the outer loop link adaptation algorithm, a SINR estimate, and the SINR backoff value
wherein the link adaptation algorithm causes a change in one or more of a modulation scheme, a coding rate, or a transmit power;
accessing, for each slot of the plurality of slots, feedback comprising second BLER data;
determining, for each slot of the plurality of slots based on the second BLER data, an updated SINR backoff value using the reinforcement learning agent;
wherein the reinforcement learning agent is configured to learn a policy based on state information comprising BLER data.

2. A method for adjusting a signal to interference and noise (SINR) backoff value, the method comprising:
accessing first block error rate (BLER) data,
wherein the first BLER data is collected by monitoring BLER at a base station for a slot;
accessing a set of features,
wherein the set of features comprises at least one of: device type of a connected device, frequency, frequency band, time of day, geolocation, traffic load, weather conditions, or historical BLER patterns;
providing the first BLER data and the set of features to a reinforcement learning agent;
determining, by the reinforcement learning agent using the first BLER data and the set of features, a SINR backoff value for the slot;
providing the SINR backoff value to the base station,
wherein the base station uses the SINR backoff value to adjust a signal transmission of the base station;
accessing feedback comprising second BLER data;
determining, based on the second BLER data, an updated SINR backoff value using the reinforcement learning agent,
wherein the reinforcement learning agent is configured to learn a policy based on state information comprising BLER data.

3. The method of claim 2, wherein the SINR backoff value indicates an amount by which a transmission power of the base station is adjusted.

4. The method of claim 2, wherein the base station is a gNodeB base station of 5G wireless telecommunications network.

5. The method of claim 2, further comprising:
providing the SINR backoff value to a link adaptation algorithm, wherein the link adaptation algorithm is configured to adjust one or more of a modulation scheme, a coding rate, or a transmit power.

6. The method of claim 5, wherein the link adaptation algorithm comprises an outer loop link adaptation algorithm and an inner loop link adaptation algorithm.

7. The method of claim 6, wherein the inner loop link adaptation algorithm is configured to determine transmission characteristics based on an outer loop offset determine by the outer loop link adaptation algorithm, a SINR estimate, and the SINR backoff value.

8. The method of claim 2, wherein the reinforcement learning agent is trained using Q-learning.

9. The method of claim 2, wherein the SINR backoff value is greater than a current SINR backoff value when the first BLER data indicates a BLER level above a first threshold value.

10. The method of claim 2, wherein the SINR backoff value is less than a current SINR backoff value when the first BLER data indicates a BLER level below a second threshold value.

11. The method of claim 2, wherein the slot comprises a plurality of slots, wherein the SINR backoff value comprises a plurality of SINR backoff values, each SINR backoff value of the plurality of SINR backoff values associated with a slot of the plurality of slots.

12. The method of claim 2, wherein the method is performed by the base station.

13. A system for adjusting a signal to interference and noise (SINR) backoff value, the system comprising:
at least one hardware processor; and
a non-transitory memory having instructed stored thereon which, when executed by the at least one hardware processor, cause the system to:
access first block error rate (BLER) data,
wherein the first BLER data is collected by monitoring BLER at a base station for a slot;
access a set of features,
wherein the set of features comprises at least one of: device type of a connected device, frequency, frequency band, time of day, geolocation, traffic load, weather conditions, or historical BLER patterns;
provide the first BLER data and the set of features to a reinforcement learning agent;
determine, by the reinforcement learning agent using the first BLER data and the set of features, a SINR backoff value for the slot;
provide the SINR backoff value to the base station,
wherein the base station uses the SINR backoff value to adjust a signal transmission of the base station;
access feedback comprising second BLER data;
determine, based on the second BLER data, an updated SINR backoff value using the reinforcement learning agent,
wherein the reinforcement learning agent is configured to learn a policy based on state information comprising BLER data.

14. The system of claim 13, further comprising:
providing the SINR backoff value to a link adaptation algorithm, wherein the link adaptation algorithm is configured to adjust one or more of a modulation scheme, a coding rate, or a transmit power.

15. The system of claim 14, wherein the link adaptation algorithm comprises an outer loop link adaptation algorithm and an inner loop link adaptation algorithm.

16. The system of claim 15, wherein the inner loop link adaptation algorithm is configured to determine transmission characteristics based on an outer loop offset determine by the outer loop link adaptation algorithm, a SINR estimate, and the SINR backoff value.

17. The system of claim 13, wherein the reinforcement learning agent is trained using Q-learning.

18. The system of claim 13, wherein the SINR backoff value is greater than a current SINR backoff value when the first BLER data indicates a BLER level above a first threshold value.

19. The system of claim 13, wherein the SINR backoff value is less than a current SINR backoff value when the first BLER data indicates a BLER level below a second threshold value.

20. The system of claim 13, wherein the slot comprises a plurality of slots, wherein the SINR backoff value comprises a plurality of SINR backoff values, each SINR backoff value of the plurality of SINR backoff values associated with a slot of the plurality of slots.
